(19) United States
(12) Patent Application Publication
(10) Pub. No.: US 2021/0197291 A1
(43) Pub. Date: Jul. 1, 2021

(54) SHRINK-FIT DEVICE AND METHOD FOR INDUCTIVELY HEATING SHRINK-FIT CHUCKS

(71) Applicant: Helmut Diebold GmbH & Co. Goldring-Werkzeugfabrik, Jungingen (DE)

(72) Inventor: Hermann Diebold, Hechingen (DE)

(21) Appl. No.: 17/192,811

(22) Filed: Mar. 4, 2021

Related U.S. Application Data
(63) Continuation of application No. PCT/EP2019/073450, filed on Sep. 3, 2019.

(30) Foreign Application Priority Data
Sep. 7, 2018 (DE) 10 2018 121 883.4

(51) Int. Cl. B23B 31/117; H05B 3/06

(52) U.S. Cl. CPC B23B 31/1179; H05B 3/06

(57) ABSTRACT

This disclosure relates to a shrink-fit device for inductively heating shrink-fit chucks for shank tools, having an accommodating region for accommodating a shrink-fit chuck, an induction coil arrangement which surrounds the accommodating region concentrically with respect to a coil axis, and a measuring unit for controlling the temperature of the shrink-fit chuck. For controlling heating, a measuring channel, which opens into the accommodating region, passes through the induction coil arrangement. The measuring unit has a temperature sensor which engages in the measuring channel for detecting a casing temperature of the shrink-fit chuck.

### RELATED APPLICATIONS

This application is a continuation of PCT/EP2019/073450, filed Sep. 3, 2019, which claims priority to DE 10 2018 121 883.4, filed Sep. 7, 2018, the entire disclosures of both of which are hereby incorporated herein by reference.

### BACKGROUND

This disclosure teaches a shrink-fit device for inductively heating or warming shrink-fit chucks for shank tools that have an accommodating region for accommodating a shrink-fit chuck, an induction coil arrangement which surrounds the accommodating region concentrically with respect to a coil axis, and a measuring unit for controlling the temperature of the shrink-fit chuck. This disclosure also relates to a method for inductively heating shrink-fit chucks.

Shrink-fit devices are generally known from DE 10 2012 216 186 A1. There, a temperature measuring device is provided which detects the surface temperature of the shrink-fit chuck in a contactless manner and which can be positioned stationarily at a relatively large distance on the shrink-fit device. For the measurement, however, an induction coil heating unit must be moved beyond the reach of the shrink-fit chuck so that the chuck surface can be scanned by the sensor. A measurement during the heating process is therefore not possible.

### SUMMARY

Proceeding from the above, this disclosure further improves the devices and methods known in the prior art and teaches a reliable shrink-fit process with a high level of safety and simple handling.

This disclosure is based on the concept of allowing direct temperature control during heating. Accordingly, it is proposed according to this disclosure that a measuring channel, which opens into the accommodating region, passes through the induction coil arrangement, and that the measuring unit has a temperature sensor which engages or is inserted into the measuring channel and measures through the channel for detecting a casing temperature of the shrink-fit chuck. This creates the possibility of directly controlling the temperature during inductive heating, i.e., during the introduction of energy. Due to the limited penetration depth, inductive heating takes place from the outside in, so that the highest temperature occurs on the chuck casing. By detecting the casing temperature, unwanted overheating of the tool holder can be avoided without the need to preset the current chuck configuration or to determine the initial temperature. This means that an operator can operate the device without worry and does not have to be concerned about possible overheating. Even an automatic heating or shutdown process is possible without difficulty.

In order to further improve the measurement, it is advantageous if the measuring channel extends through the induction coil arrangement transversely, in particular radially, to the coil axis.

In this context, it is also advantageous if the measuring channel is arranged in an axial central region of the induction coil arrangement, preferably centrally between the axial ends thereof.

In order to implement a measuring window, it is advantageous if the induction coil arrangement has a coil winding that is wound while keeping the measuring channel free.

In another improvement, the measuring channel comprises an opening through a housing of the induction coil arrangement.

In order to create consistently reliable positioning, it is advantageous if the temperature sensor is arranged at least in part in the measuring channel.

In order to maintain constant measurement conditions, it is particularly advantageous if the temperature sensor is designed for contactless detection of the casing temperature.

In this context, it is favorable if the measuring unit is designed as a pyrometer and has a radiation detector as a temperature sensor which is aligned with the accommodating space and which detects thermal radiation emitted by a shrink-fit chuck located therein.

In a particularly advantageous embodiment, a protective window which is permeable to thermal radiation and is preferably replaceable is inserted into the measuring channel in particular to protect the temperature sensor from contamination.

In order to further simplify handling, it is particularly advantageous if a device which comprises the measuring unit and influences the power supply to the induction coil arrangement in accordance with the casing temperature is provided for controlling the heating of the shrink-fit chuck during heating.

In terms of the method, the object mentioned at the outset is achieved in that a casing temperature of the shrink-fit chuck is detected via a measuring channel passing through the induction coil arrangement. The advantages already explained above for the device can thus be achieved in an analogous manner.

In order to avoid overheating or to regulate the temperature, it is advantageous if the power supply to the induction coil arrangement is influenced depending on the casing temperature.

In order to maintain the desired temperature and thus also to extend the handling time for inserting and removing the tool, it is advantageous if the casing temperature is brought to a predetermined target value by controlling the power supply to the induction coil arrangement and is optionally kept at this target value.

A simple overheating protection can be implemented in that the power supply to the induction coil arrangement is maintained or reduced or switched off when a predetermined target value of the casing temperature is reached.

In order to introduce the heating energy in a targeted and defined manner, it is advantageous if the shrink-fit chuck is positioned relative to the temperature sensor by means of a stop. At the same time, undesired stray fields can be minimized by a pole disk of the induction coil arrangement that forms the stop and can be replaced if necessary.

A further improvement results from the fact that the measured casing temperature is displayed for an operator via a display of the measuring unit.

A particularly clear representation can be achieved in that the casing temperature is visualized by means of light-emitting diodes, preferably colored in the manner of a traffic light.

The casing temperature is advantageously measured during the inductive heating and/or in a time interval shortly thereafter.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is an axial section of a shrink-fit device with integrated heating control for a shrink-fit chuck to be heated;

FIG. 2 is a perspective view of an induction coil arrangement of the shrink-fit device with a transverse opening as a measuring channel; and

FIG. 3 is a radial section in the region of the measuring channel through the induction coil arrangement according to FIG. 2.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

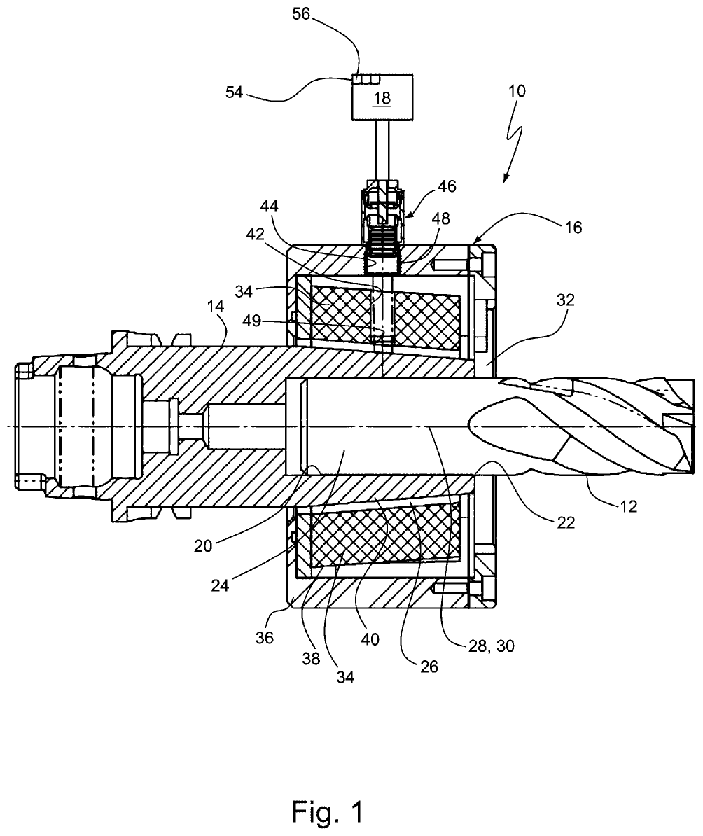

The shrink-fit device 10 shown in FIG. 1 is used to shrink a shaft tool 12 into or out of a shrink-fit chuck 14. For this purpose, it comprises an induction coil arrangement 16 for inductively heating the shrink-fit chuck 14 and a control unit (also referred to as a “controller”) 18, shown only symbolically, for controlling the heating of the shrink-fit chuck 14.

The shrink-fit chuck 14 comprises, as a sleeve part, a cylindrically hollow clamping region 20, which is accessible via an end opening 22 at the front end of the shrink-fit chuck 14 for inserting the tool shaft 24. The clamping region 20 has a slightly smaller nominal diameter than the tool shank 24, such that it can be clamped in a manner known per se by (inductive) heating of the shrink-fit chuck 14. In the shrunk-on state, the tool shank 24 is held in a press fit in a frictional manner in order to transmit a torque to the front working portion of the rotary tool 12. For shrinking out, only the shrink-fit chuck 14 is heated on one side until the thermal expansion releases the tool shank 24 for removal.

The induction coil arrangement 16 encloses an accommodating region 26 for the shrink-fit chuck 14 in a concentric arrangement with respect to the coil axis 28 or tool axis 30. The shrink-fit chuck 14 is brought into the heating position shown by an axial movement relative to the induction coil arrangement 16. The shrink-fit chuck 14 can be axially positioned by means of a pole disk 32 acting as a stop.

In order to generate an electromagnetic alternating field, the induction coil arrangement 16 contains a coil winding 34, shown symbolically hatched, in a coil housing 36. The coil winding 34 is enclosed in a casting compound 38, the inner cavity being adapted to the conical shape of the casing 40 of the shrink-fit chuck 14.

In order to be able to detect the casing temperature of the shrink-fit chuck 14 during heating, a measuring channel 42, which opens into the accommodating region 26, passes through the induction coil arrangement 16 radially with respect to the coil axis 28. In this case, the measuring channel 42 is expediently arranged in an axial central region of the induction coil arrangement 16, preferably centrally between the ends thereof, the coil winding 34 being wound around the measuring channel 42 while keeping said measuring channel free. The inner portion of the measuring channel 42 on the coil side is aligned with an opening 44 in the outer wall 38 of the coil housing 36.

The control unit 18 is coupled on the input side to a measuring unit 46 for detecting a casing temperature of the shrink-fit chuck 14. For this purpose, the measuring unit 46 is designed as a pyrometer for contactless temperature detection.

The measuring unit 46, which operates pyrometrically in a manner known per se, has a radiation detector as a temperature sensor 48 which is inserted into the opening 44 and which detects heat radiation emitted by the shrink-fit chuck 14 through the measuring channel 42 in the coil winding 34. As a result, the temperature can be controlled during the heating of the shrink-fit chuck 14 and optionally the power supply to the induction coil arrangement 16 can be influenced depending on the casing temperature. In order to protect the temperature sensor 48 from contamination, a protective window 49 which is permeable to thermal radiation is inserted into the measuring channel 42.

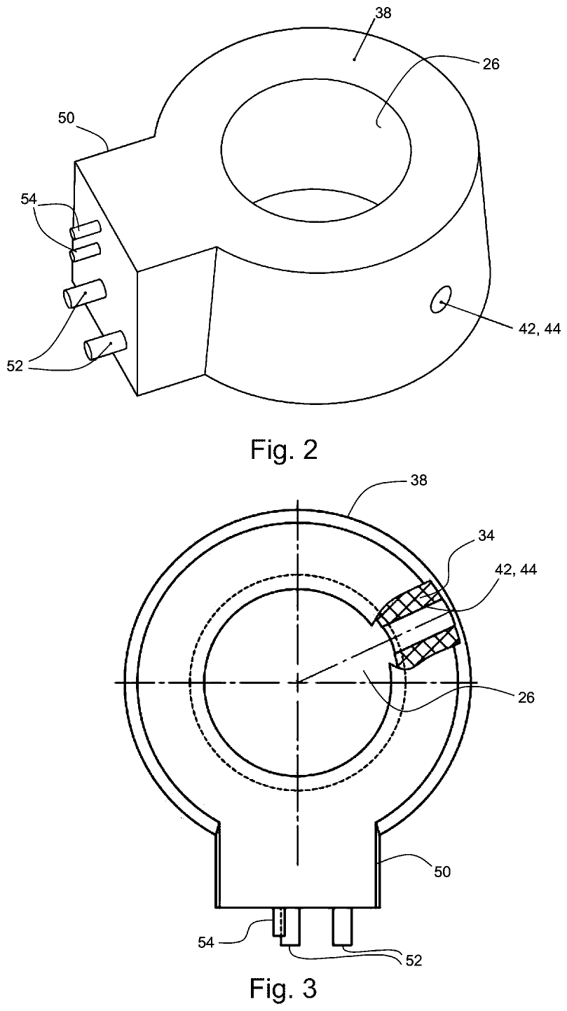

As can be seen from FIGS. 2 and 3, the cast-in coil winding 34 has an extension 50 on which the power connections 52 are accessible for the power supply. It is possible to control the temperature of the coil winding 34 on the basis of a PTC sensor (not shown) via additional measuring connections 54.

During operation of the shrink-fit device 10, the control unit (controller) 18 connected on the output side to the power connections 52 of the induction coil arrangement 16 can bring the casing temperature to a predetermined target value by controlling the power supply and optionally keep it at this target value. The control unit 18 can act as a closed-loop control device in a closed control loop. In a simplified mode of operation, it is also conceivable for the power supply to the induction coil arrangement 16 to be reduced or switched off when a predetermined target value of the casing temperature is reached.

The measured casing temperature can be displayed for an operator via a display 54 control unit 18. This can be done particularly clearly by visualizing the casing temperature by means of light-emitting diodes 56 colored in the manner of a traffic light.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A shrink-fit device for inductively heating shrink-fit chucks for shank tools, the device comprising:
an accommodating region configured to accommodate a shrink-fit chuck;
an induction coil arrangement surrounding the accommodating region concentrically with respect to a coil axis;
a measuring channel passing through the induction coil arrangement and opening into the accommodating region; and
a measuring unit configured to control the temperature of the shrink-fit chuck, the measuring unit including a temperature sensor configured for detecting via the measuring channel a casing temperature of the shrink-fit chuck.

2. The shrink-fit device according to claim 1, wherein the measuring channel extends through the induction coil arrangement transversely to the coil axis.

3. The shrink-fit device according to claim 2, wherein the measuring channel is arranged radially with respect to the coil axis.

4. The shrink-fit device according to claim 1, wherein the measuring channel is arranged in an axial central region of the induction coil arrangement.

5. The shrink-fit device according to claim 4, wherein the measuring channel is arranged centrally between the ends of the induction coil arrangement.

6. The shrink-fit device according to claim 1, wherein the induction coil arrangement has a coil winding which is wound and the measuring channel is open.

7. The shrink-fit device according to claim 1, wherein the measuring channel comprises an opening through a housing of the induction coil arrangement.

8. The shrink-fit device according to claim 1, wherein the temperature sensor is arranged at least partly in the measuring channel.

9. The shrink-fit device according to claim 1, wherein the temperature sensor is configured for contactless detection of the casing temperature.

10. The shrink-fit device according to claim 1, wherein the measuring unit comprises a pyrometer and the temperature sensor is a radiation detector aligned with the accommodating region, the radiation detector configured to detect thermal radiation emitted by a shrink-fit chuck located in the accommodating region.

11. The shrink-fit device according to claim 1, further comprising a thermal radiation-permeable protective window placed in the measuring channel to protect the temperature sensor from contamination.

12. The shrink-fit device according to claim 1, further comprising a controller for controlling the heating of the shrink-fit chuck during heating, the controller configured to influence the power supply to the induction coil arrangement as a function of the casing temperature.

13. A method for inductively heating a shrink-fit chuck in a shrink-fit device, the method comprising:
placing a shrink-fit chuck into an accommodating region of the shrink-fit device;
heating an induction coil arrangement that concentrically surrounds the accommodating region and thereby inductively heating the shrink-fit chuck, whereby the shrink-fit chuck thermally expands; and
controlling the temperature of the shrink-fit chuck using a measuring unit in which a casing temperature of the shrink-fit chuck is detected via a measuring channel passing through the induction coil arrangement.

14. The method of claim 13, wherein power provided to the induction coil arrangement is varied depending on casing temperature.

15. The method according to claim 13, wherein the casing temperature is brought to a predetermined target value by controlling a power supply to the induction coil arrangement.

16. The method according to claim 15, further comprising maintaining the temperature at the predetermined target value.

17. The method according to claim 13, wherein a power supply to the induction coil arrangement is maintained or reduced or switched off when a predetermined target value of the casing temperature is reached.

18. The method according to claim 13, wherein the shrink-fit chuck is positioned relative to the temperature sensor by a stop.

19. The method of claim 18, wherein the stop comprises a pole disk of the induction coil arrangement.

20. The method according to claim 13, wherein the measured casing temperature is displayed for an operator via a display.

21. The method according to any of claim 13, wherein the casing temperature is displayed with light-emitting diodes.

22. The method according to claim 21, wherein the light emitting diodes ac colored in the manner of a traffic light.

23. The method according to claim 13, wherein the casing temperature is measured during the inductive heating and/or in a time interval thereafter.
